(19) United States
(12) Patent Application Publication
(10) Pub. No.: US 2016/0189127 A1
(43) Pub. Date: Jun. 30, 2016

(54) Systems And Methods For Creating Dynamic Programmable Credential and Security Cards

(71) Applicant: Qvivr, Inc., Santa Clara, CA (US)

(72) Inventors: Kuldeep Amarnath, Fremont, CA (US); Ashutosh Dhodapkar, Fremont, CA (US)

(73) Assignee: QVIVR, INC., Santa Clara, CA (US)

(21) Appl. No.: 14/948,219

(22) Filed: Nov. 20, 2015

Related U.S. Application Data
(60) Provisional application No. 62/082,869, filed on Nov. 21, 2014.

(51) Int. Cl. G06Q 20/20; G06K 19/06

(52) U.S. Cl. CPC G06Q 20/206; G06K 19/06037; G06Q 20/202

(57) ABSTRACT

A dynamic credential card system for interoperating with multiple different point-of-sale systems is disclosed. The system comprises three computer systems: a dynamic digital value transfer system operating on a server, a dynamic digital value transfer application operating on a mobile digital device, and a small programmable dynamic credential card system. The dynamic digital value transfer system interoperates with third party payment systems and communicates with the dynamic digital value transfer application. The dynamic digital value transfer application communicates with the small programmable dynamic credential card system. The small programmable dynamic credential card system has at least one Point-of-Sale communication system for communicating with retail Point-Of-Sale terminals.

### RELATED APPLICATIONS

The present application claims the benefit of the earlier filed U.S. Provisional patent application titled “Programmable Payment Cards with Dynamic Identifiers” having Ser. No. 62/082,869 that was filed on Nov. 21, 2014.

### TECHNICAL FIELD

The present invention relates to the field of electronic payment systems. In particular, but not by way of limitation, the present invention discloses techniques for implementing dynamic programmable credential and security cards.

### BACKGROUND

Magnetic stripes are very often used for storing information that can be quickly read back when necessary. A magnetic stripe card is a physical card typically made of hard plastic or another suitable material that contains a band or stripe of magnetic material such as iron-based particles. Digital information, such as an identifier, may be magnetically encoded on the magnetic stripe as a series of magnetic polarity reversals. The encoded digital information can subsequently be read back by swiping the magnetic stripe past a magnetic reading head. Magnetic stripe cards are commonly used as gift cards, prepaid cards, other types of stored value cards, credit cards, debit cards, employee ID cards, etc.

With conventional magnetic stripe cards, the digital identification (or credential) information is encoded onto the magnetic stripe on the magnetic stripe card before the magnetic stripe card is issued to the user of the magnetic stripe card. The user of the magnetic stripe card may then subsequently swipe the magnetic stripe card on an appropriate magnetic card reader that will then read back the encoded digital identification information. For example, a user may swipe a credit card with a magnetic stripe at a retail Point-Of-Sale (POS) terminal that will read the digital identification information encoded on the magnetic stripe card. The encoded digital identification information (or credentials) on a magnetic stripe card is in the form of a static digital identifier such as a card identification number, an account number, a credit card number, an employee identifier, etc.

Numerous other types of credential cards have become popular such as EMV cards, Radio Frequency Identifier (RFID) cards, Near Field Communication (NFC) cards, barcode cards, and other cards. These credential cards have become so popular that many people now carry around a large multitude of plastic credential cards. For example, a person may carry several credit cards, ATM cards, debit cards, a driver's license, library cards, retailer loyalty cards, RFID security cards, EMV cards, electric car charging cards, security access cards, and other plastic cards with magnetic stripes, RFID markers, EMV chips, bar codes, or other identifiers.

Although traditional magnetic stripe cards have proven to be very useful, there are substantial areas wherein magnetic stripe cards can be improved. For example, the security provided by magnetic stripe payment cards is not strong. It is relatively easy for skilled criminals to duplicate a magnetic stripe payment card. New types of payment cards, such as EMV payment cards and RFID payment cards, are being introduced to improve the security of payment card systems. However, EMV and RFID payment cards may still be stolen and used by the thief that has the stolen EMV or RFID payment card.

Furthermore, the growth in the use of plastic cards with credential systems can make things difficult to manage for people that have many plastic cards with credential systems. For example, a wallet storing many plastic cards such as credit cards, a driver's license, student ID cards, debit cards, store loyalty cards, library cards, membership cards, insurance cards, electric car charging cards, etc. can become quite thick and unwieldy. Furthermore, when a person needs to use one specific plastic card for a specific situation out of the many different plastic cards being carried that person may have to take the time to shuffle through the large stack of plastic cards with various different credential systems in order to find the specific plastic card needed for the current situation.

Another problem with current plastic credential cards is that when such credential cards are lost or stolen, the user must notify the card issuer about the lost or stolen card. When an entire wallet is lost, that is a large number of card issuers that must be notified. Then the various credential card issuers must all create and mail new cards thus costing time and money.

Due to these security issues and growth in usage issues associated with plastic credential cards, it would therefore be desirable to implement systems and methods that improve the security and convenience of credential and security card systems.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of a machine in the example form of a computer system within which a set of instructions, for causing the machine to perform any one or more of the methodologies discussed herein, may be executed.

FIG. 2 illustrates a conventional three track magnetic stripe card that is commonly used for credit cards and debit cards.

FIG. 3 illustrates a programmable dynamic magnetic stripe card with a solenoid coil that may generate a magnetic field.

FIG. 4 illustrates a block diagram of an exemplary network architecture in which a dynamic digital value transfer system may be implemented for a programmable dynamic financial credential card.

FIG. 5 illustrates a block diagram of a programmable dynamic credential card that may support many accounts and many types of Point-Of-Sale terminals.

FIG. 6 illustrates a flow diagram describing how a new financial payment account may be added to the programmable dynamic credential card of FIG. 5.

FIG. 7 illustrates a flow diagram describing how the programmable dynamic credential card of FIG. 5 may be used to make purchases at a brick & mortar retail establishment.

FIG. 8 illustrates a flow diagram describing how the programmable dynamic credential card of FIG. 5 may be used to make purchases with two different security tokens thus improving security.

FIG. 9 illustrates a flow diagram describing how the programmable dynamic credential card of FIG. 5 may obtain one-time usage account numbers.

FIG. 10 illustrates a flow diagram describing how the programmable dynamic credential card of FIG. 5 may be used to provide dynamic CVV numbers to improve security.

FIG. 11 illustrates a flow diagram describing a first embodiment of using a programmable dynamic credential card to provide greater security to an application running on an associated mobile digital device.

FIG. 12 illustrates an alternate embodiment of a system that uses the security functionality of a programmable dynamic credential card to provide greater security to an application running on an associated mobile digital device.

The Figures depict various embodiments for purposes of illustration only. One skilled in the art will readily recognize from the following discussion that other embodiments of the structures and methods illustrated herein may be employed without departing from the described principles.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although some example embodiments are disclosed with reference to credit cards and other payment cards, the teachings of this disclosure may be used to provide any type of credential card with useful technologies. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

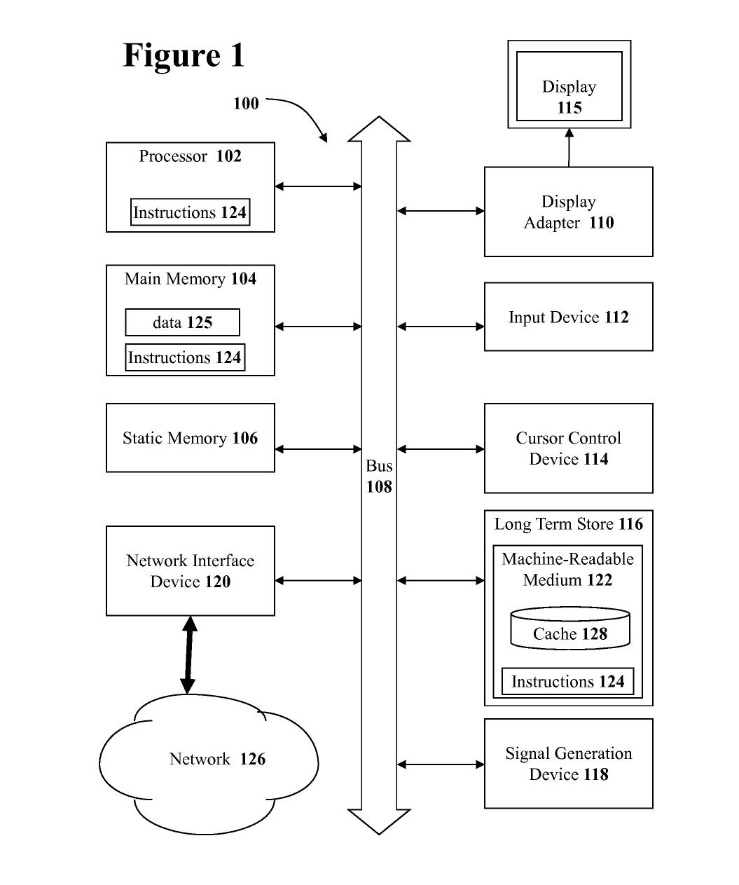

Some embodiments of the present disclosure may use computer systems since computer systems are very often used in conjunction with magnetic stripe systems. FIG. 1 illustrates a diagrammatic representation of a machine in the example form of a computer system 100 that may be used to implement portions of the present disclosure. Within computer system 100 there are a set of instructions 124 that may be executed for causing the machine to perform any one or more of the methodologies discussed herein. In a networked deployment, the machine may operate in the capacity of a server machine or a client machine in client-server network environment, or as a peer machine in a peer-to-peer (or distributed) network environment. The machine may be a small card, personal computer (PC), a tablet PC, a set-top box (STB), a Personal Digital Assistant (PDA), a cellular telephone, a web appliance, a network router, switch or bridge, or any machine capable of executing a set of computer instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a static memory 106, which communicate with each other via a bus 108. The computer system 100 may further include a display adapter 110 that drives a display system 115 such as a Liquid Crystal Display (LCD), Cathode Ray Tube (CRT), or other suitable display system. The computer system 100 may also include an input device 112 (e.g., a keyboard), a cursor control device 114 (e.g., a trackpad, mouse, or trackball), a long term storage unit 116, an output signal generation device 118, and a network interface device 120.

The long term storage unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within the processor 102 during execution thereof by the computer system 100, the main memory 104 and the processor 102 also constituting machine-readable media. Note that the example computer system 100 illustrates only one possible example and that other computers may not have all of the components illustrated in FIG. 1 or may have additional components as needed.

The instructions 124 may further be transmitted or received over a computer network 126 via the network interface device 120. Such transmissions may occur utilizing any one of a number of well-known transfer protocols such as the File Transport Protocol (FTP). The network interface device 120 may comprise one or more wireless network interfaces such as Wi-Fi, cellular telephone network interfaces, Bluetooth, Bluetooth LE, Near Field Communication (NFC), etc.

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, flash memory, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

In the present disclosure, a computer system may comprise a very small microcontroller system. A microcontroller may comprise a single integrated circuit that contains the four main components that create a computer system: an arithmetic and logic unit (ALU), a control unit, a memory system, and an input and output system (collectively termed I/O). Microcontrollers are very small and inexpensive integrated circuits that are very often used within digital electronic devices. A microcontroller may be integrated along with other functions to create a system on a chip (SOC).

Magnetic Stripe Cards Overview

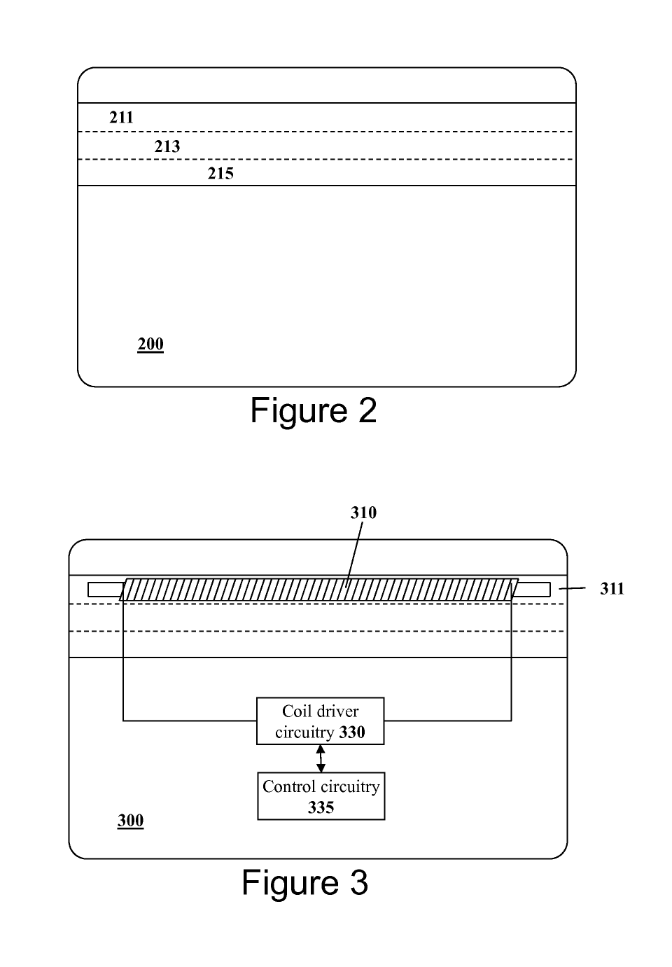

A magnetic stripe card is a physical card typically made of hard plastic or another suitable material that contains a band or stripe of magnetic material. The magnetic stripe on a magnetic stripe card is typically contained in a plastic-like film for protection. Conventionally, the magnetic stripe is located 0.223 inches (5.66 mm) from the upper edge of the physical card. A conventional magnetic stripe on a conventional magnetic stripe card 200 may contain three distinct magnetic tracks 211, 213, and 215 as illustrated in FIG. 2. Each of these individual magnetic tracks is 0.110 inches (2.79 mm) wide. Some magnetic stripe cards only have two tracks or even just one track.

Digital data such as an identifier can be magnetically encoded on the magnetic tracks 211, 213, and 215 of the magnetic stripe area. The encoded information can subsequently be read by swiping the magnetic stripe past a magnetic sensor or read-head. Magnetic stripe cards are commonly used as gift cards, prepaid cards, other types of stored value cards, credit cards, debit cards, employee ID cards, etc.

With conventional magnetic stripe cards, the magnetic stripe card issuer encodes specific information onto the magnetic stripe card before the magnetic stripe card is issued to a magnetic stripe card user. Thereafter, when the magnetic stripe card user swipes the magnetic stripe card on an appropriate magnetic stripe card reader, the magnetic stripe card reader will obtain the information encoded onto the card and use that information for some type of transaction. For example, a magnetic stripe card user may swipe a financial magnetic stripe card at a Point-Of-Sale (POS) terminal to purchase an item. The information encoded onto a magnetic stripe card is generally in the form of a static identifier such as a card identification number, an account number, a credit card number, an employee identifier, etc. In the United States of America, the magnetic stripe card is the most common form of financial payment card.

Financial Application Magnetic Stripe Cards

Magnetic stripe cards may be used for a very large number of different applications. As previously mentioned, magnetic stripe cards may be used as personal identification cards (employee identification cards, driver's licenses, student identification, etc.) However, one of the most common applications of magnetic stripe cards is for facilitating financial transactions.

A first type of financial magnetic stripe card is a stored value magnetic stripe card such as a gift cards and prepaid cards. Stored value magnetic stripe cards can be associated with a financial value (e.g., $10, $50, $200) that can be spent at a designated merchant (e.g., Target, Starbuck's, Amazon, etc.). Other financial magnetic stripe cards include prepaid debit cards that virtually store a monetary value that may be spent at any merchant that accepts the prepaid debit card type (e.g., Visa, American Express, MasterCard, etc.). With non-prepaid debit cards, the associated monetary value is typically an amount stored in an associated bank account. The most well-known type of financial magnetic stripe card is the common credit card. With credit card type of financial magnetic stripe card, the value associated with the card is an associated line of credit (i.e., the amount remaining on the credit limit).

In all of these different cases of financial magnetic stripe cards, when the magnetic stripe card is presented at a merchant, the static identifying information encoded on the magnetic stripe of the magnetic stripe card (e.g., the account number, the credit card number, etc.) is used to lookup an associated value, from which the amount of the financial transaction is deducted. For security reasons, the actual value associated with the financial magnetic stripe card is not stored directly on the financial magnetic stripe card itself, but instead on a server computer system accessible from the Point-Of-Sale (POS) terminal over a network.

Financial value can be added to a conventional financial magnetic stripe card. For example, a financial magnetic stripe card holder may present physical currency to a retail merchant and asks to have the value added to an existing card. Similarly, a financial value card owner may deposit money in a bank account, make a payment on a credit card, or perform another payment activity to add value to the account associated with a card. In any case, the dynamic financial value associated with the financial magnetic stripe card is stored by a server computer system such that the static identifying information on the financial magnetic stripe card can be used to access the dynamic off-card financial value information.

In addition to physical points of sale, online merchants and payment services allow the spending and replenishing of value associated with financial magnetic stripe cards. E-commerce sites enable customers to make purchases online by entering static identifiers such as credit card numbers or gift card numbers. Other online services enable consumers to make payments to add value to an existing financial magnetic stripe card, transfer funds between different accounts, make payments on credit cards, and perform other tasks. As when financial value is deducted from or added to an existing financial magnetic stripe card at a physical Point-Of-Sale (POS), the dynamic off-card data representing the financial value is retrieved and updated although the static information on the financial magnetic stripe card is not changed. Although online services allow using a financial magnetic stripe card without being present at a physical merchant site, the consumer is still locked into specific, separate financial magnetic stripe cards associated with specific merchants, payment networks, and financial institutions.

One drawback of financial magnetic stripe cards is that they are not very secure. The technology required to encode an identifier onto a magnetic stripe card is rather trivial in the modern world. A financial magnetic stripe card thus amounts to an easy to copy security token. Thus, billions of dollars are lost due to credit card fraud every year.

Other Financial Application Cards and Payment Systems

A new system for making payments with financial cards other than magnetic stripe cards is the “Europay, MasterCard, and Visa” system better known by the initials “EMV”. The EMV system has a much better security system than a conventional financial magnetic stripe card. The EMV system is a standard for financial cards containing embedded integrated circuits that perform security operations. The EMV cards are commonly called IC cards, chip cards, or dip cards. EMV cards may be contact cards that must be physically inserted (or “dipped”) into an EMV card reader or EMV cards may be contactless cards that can be read over a short distance using radio-frequency identification (RFID) technology. There are standards based on ISO/IEC 7816 for contact EMV cards and standards based on ISO/IEC 14443 for contactless EMV cards.

EMV cards can interact with EMV capable Point-Of-Sale (POS) terminals and automated teller machines (ATMs) to authenticate credit card or debit card transactions. EMV chip card transactions improve security over traditional magnetic stripe cards because the IC card contains an embedded microchip that is very difficult to copy. Furthermore, the transactions may further require authentication using a consumer's Personal Identification Number (PIN). At a Point-Of-Sale (POS), the chip on the EMV card communicates with the Point-Of-Sale (POS) terminal and the consumer enters a Personal Identification Number (PIN). When the Point-Of-Sale (POS) terminal is connected to the network, the authenticity of the card and chip can be confirmed along with the consumer's Personal Identification Number (PIN). Specifically, the POS terminal may communicate with a backend sever (such as that of a bank) to verify the chip on the card and consumer-entered PIN. If the Point-Of-Sale (POS) terminal is not connected to a network, the chip on the EMV card may communicate to the POS terminal whether the PIN was entered correctly. Due to this ability to authenticate a chip and a consumer-entered PIN, the EMV system is sometimes called “chip and PIN” system.

Whereas EMV system is a more secure interface than traditional magnetic stripe cards, the value associated with an EMV card is still in the online world. Specifically, the financial value associated with EMV card is stored on the backend server of an associated financial institution and the identifier encoded on the physical EMV card is still a static value that is used for identification and authentication.

In addition to the new EMV system, other types of interfaces for financial transaction cards also exist such as touch based or contactless interfaces on the card that communicate the financial card's static identifier to an appropriate card reader using a short range wireless communication protocol. For example, Near Field Communication (NFC) cards may communicate with a specially enabled NFC Point-Of-Sale (POS) terminal. Examples of such wireless payment systems include PayPass, payWave, and ExpressPay. These wireless interfaces add a level of convenience at the POS. But as with the previously described financial card systems, the identifier on the NFC type of financial card is static and associated with a single account with a financial value stored and tracked on a backend server.

Another type of contactless interface that may be used on financial payment cards is the Low Energy Bluetooth system known as Bluetooth LE, BLE, or Bluetooth Smart. Bluetooth LE is similar to the well-known Bluetooth wireless communication system but is intended to provide considerably reduced power consumption and cost while maintaining a similar communication range.

A different type of financial currency that is now commonly used is gift cards, reward cards, or loyalty cards. Such cards often use some type of QR code, bar code, or other identifier that is linked to an associated value amount.

Another type of card that may be used is a virtual E-Gift card. An E-gift may be distributed as an alphanumeric code that may be used as an online type of financial currency for internet purchases. E-gift cards may distributed by sending an e-mail or similar electronic communication that includes a coded number or a coded image (Such as a QR code or a bar code) that may be printed. The resulting hardcopy of the image may then be presented to a merchant, where it is scanned and utilized similar to a plastic gift card. In other words, a static identifier is encoded in the image and when the image is scanned by a Point-Of-Sale (POS) terminal, the POS terminal can decode the image into an identifier and then look up dynamic information such as the remaining value associated with e-gift card.

Services exist that allow such e-gift cards to be purchased and sent electronically to a desired recipient. However, the recipient still often needs to print the e-gift card to redeem it with a retailer. With some systems, the QR codes, bar codes, or other scannable image with an identifier may also be displayed on the screens of mobile computing devices such as smartphones or tablets. However, displaying an encoded identifier image presents some of same shortcomings as hardcopy barcodes. Furthermore, images displayed on the LCD or LED screens of a small mobile computing device are often difficult to scan accurately. Specifically, display systems generally emit light to create an image whereas a scanner system generally operates with a reflected image.

Financial Card System Shortcomings

With conventional physical payment cards and printable e-gift cards (collectively “financial cards”), each financial card is statically associated with a single merchant, financial institution, or payment network. Thus, consumers often end up having to carrying a large number of different financial cards or finding themselves without a specific financial card needed for use when at a particular store. Furthermore, to give e-gift cards to others, a consumer must give a specific financial card (whether a physical financial card or printable e-gift financial card) that is associated with a specific merchant, financial institution, or payment network such that the gifted financial card is not usable across multiple contexts. Likewise, to add value to one's own financial cards or to add value to the financial cards of others as a gift, consumers must separately add value to each specific financial card associated with each individual target. Every purchase of value on a conventional financial card, either for one's own use or to be given to another, locks the end consumer into spending the purchased value within the specific target context (specific merchant, financial institution, or payment network) of the specific financial card. It would be desirable to have a more flexible financial card system that prevents such limited use.

In addition to value in traditional currency such as U.S. dollars or Euros (with or without restrictions concerning where can currency can be spent), other forms of electronic value also exist that are of interest in these contexts. For example, there are electronic services that enable peer-to-peer exchange of financial payments such as Venmo and PayPal. These financial payment services allow consumers to pay each other or online merchants electronically from desktop computers or mobile digital devices such as smartphones. However, these payments are locked in the online world and generally cannot be used in traditional brick and mortar stores. New crypto-currencies such as Bitcoin, digital representations of traditional currencies such as “e-checks” (the Automated Clearing House system known as ‘ACH’), and reward point systems also enable electronic payments and transactions. However, such crypto-currencies and reward point cards are also generally unable to interface with most Point-Of-Sale (POS) systems in the physical world. Thus, it would be desirable to have an electronic financial payment system that can easily be used in both the online world and the brick & mortar physical world.

With virtually all of the current financial card systems and electronic payment systems (including credit cards, debit cards, e-gift cards, PayPal, Bitcoin, etc.) there is at most only one security token. And with some of these financial payment systems, the security token may easily be copied (such as a credit card magnetic strip). Other systems use passwords or PIN codes that may be stolen with keystroke loggers or video camera systems. Thus it would be desirable to improve the security of all such financial card systems and electronic payment systems.

A Comprehensive Financial Application Card System

The present document introduces a new programmable dynamic credential card system that is far more flexible and yet more secure than existing financial payment card systems and electronic payment systems. The programmable dynamic credential card system of this disclosure is flexible in that a single electronic card device may be used to represent many different conventional financial payment cards (such as credit cards, e-gift cards, debit cards, electronic payments, etc.). While being more flexible than existing financial card systems, the programmable dynamic credential card system of this disclosure manages to be more secure than conventional financial payment cards since two different security tokens (one in the electronic programmable dynamic credential card device and another in a consumer's cellular telephone or other mobile digital device) may be used thereby improving security. These two different features greatly improve both the flexibility and security of the programmable dynamic credential card system of the present disclosure.

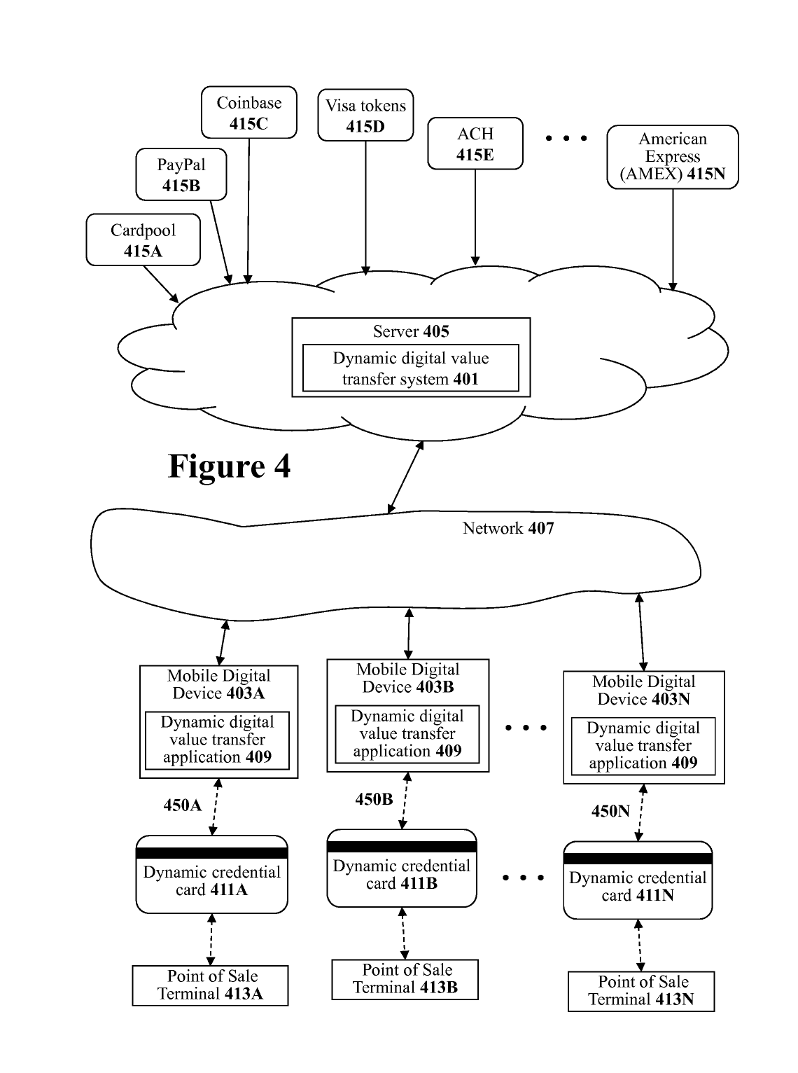

FIG. 4 illustrates a block diagram of an exemplary network architecture in which a dynamic digital value transfer system 401 may be implemented for the financial card system of the present disclosure. The illustrated network architecture comprises a server 405 that is depicted in the cloud such that applications running on the server 405 can be configured for access over a network 407 as a service. Although network 407 is illustrated as a single network, it actually represents one or more of many different possible networks such as the Internet, a cellular network, a wireless network, an enterprise intranet, or any other suitable communication network. In FIG. 4, the dynamic digital value transfer system 401 is illustrated as residing on server 405. It is to be understood that this is an example only, and in various embodiments various functionalities of the dynamic digital value transfer system 401 can be can be distributed between multiple computing devices, including multiple servers 405, mobile communication devices 403, desktop based client computers, etc.

FIG. 4 also illustrates multiple mobile communication devices 403A, 403B, and 403N that may communicate with the dynamic digital value transfer system 401 through network 407. Each mobile computing device 403 is illustrated as running a dynamic digital value transfer application 409 that communicates with the backend dynamic digital value transfer system 401. The dynamic digital value transfer application 409 acts as a user operated frontend to the dynamic digital value transfer system 401. The functionalities described herein as being performed by the dynamic digital value transfer system 401 and the dynamic digital value transfer application 409 can be distributed between the server(s) 405 and mobile communication device(s) 403 in other ways in other embodiments. Furthermore, functionality may be distributed between multiple different computer systems 100 as desired. In some embodiments, some of the mobile computing devices 403 are replaced by desktop based client computing devices such that the functionality described herein as being performed by the dynamic digital value transfer application 409 can instead be executed by a desktop based application (not shown).

It is to be understood that the mobile digital devices 403 described herein comprise mobile digital devices (such as computer system 100) capable of connecting to a network 407 and running application programs (commonly referred to as ‘apps’). One class of such mobile digital devices 403 include smartphones but even many mobile phones not so designated have these capabilities. Examples of mobile digital devices include but are not limited to smartphones, tablet computers, smart watches, other wearable computing devices, laptop computer system, hybrids, convertible laptops, vehicle computer systems, etc.

In addition to communicating on network 407, each mobile digital device 403 may communicate wirelessly with a programmable dynamic credential card 411. Wireless communication protocols that may be used include Bluetooth, Wi-Fi, Bluetooth LE, Near Field Communication (NFC), or any other suitable communication protocol. In some embodiments, programmable dynamic credential cards 411 also comprise display systems to display information to users such as text and images such as bar codes and QR codes.

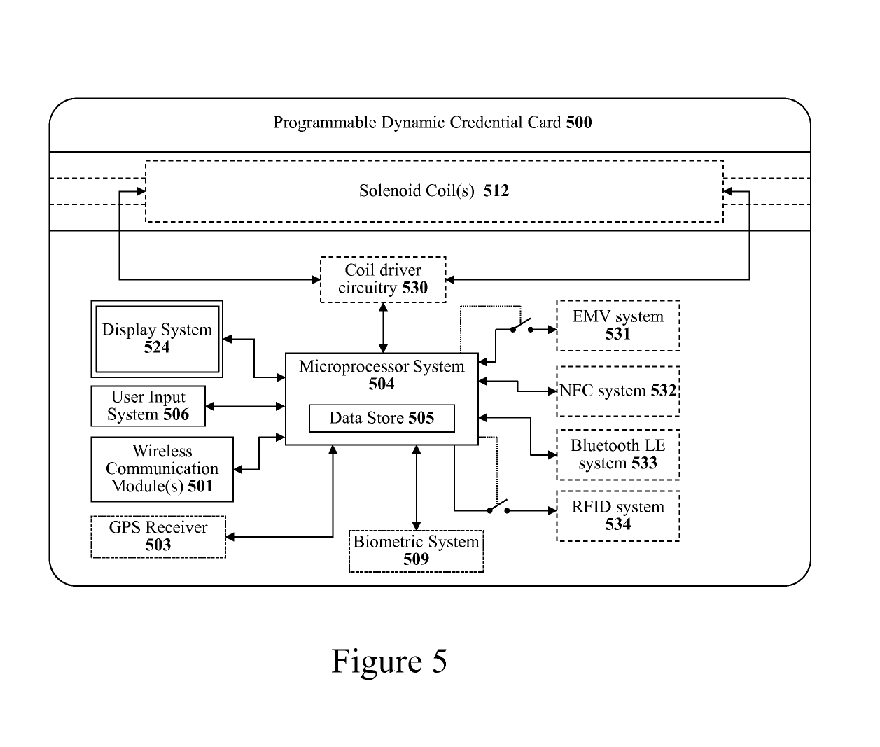

In one embodiment, a programmable dynamic credential card 411 is in the form of a dynamic programmable magnetic stripe card 300 that includes a solenoid coil 310 in the magnetic stripe area 311. The solenoid coil 310 may be driven by coil driver circuitry 330 which can be controlled by control circuitry 335 in order to dynamically generate a magnetic signal. The control circuitry 335 on the card may be dynamically updated with new information in order to generate various different magnetic identifier signals in the magnetic stripe area 311 as opposed to a conventional magnetic stripe than can only store a static identifier. Dynamic programmable magnetic stripe cards 300 are described in more detail in a later section of this document with reference to FIG. 5. Furthermore, additional detailed information on programmable dynamic magnetic stripe cards can be found in the co-pending U.S. patent application title “Systems And Methods For Creating Dynamic Programmable Magnetic Stripes”, filed on Oct. 26, 2015 and having Ser. No. 14/922,771.

FIG. 4 further illustrates merchant Point-Of-Sale (POS) systems 413A through 413N. The Point-Of-Sale (POS) systems can be in the form of any type of conventional Point-Of-Sale (POS) terminal with a conventional magnetic stripe card reader, an EMV chip reader, a Near Field Communication (NFC) reader, a Bluetooth communication system, an image scanner for reading bar codes and QR codes, an RFID reader, or any other suitable reader for reading information from financial payment cards (both conventional and programmable dynamic credential cards) at any physical retailer or merchant. In another embodiment, one time use tokens may be used, as described in more detail below. Regardless of the particular card reader interface used, the Point-Of-Sale (POS) terminal 413A is able to use the information retrieved from the programmable dynamic credential card 411A to access the financial value associated with that programmable dynamic credential card 411A from a financial server across a network (not shown).

Several third party payment services 415A through 415N are also illustrated in network architecture diagram of FIG. 4. The third party payment services may communicate with the dynamic digital value transfer system 401 through appropriate network connections. FIG. 4 illustrates six specific examples of third party payment services: Cardpool 415A, PayPal 415B, Coinbase 415C (a Bitcoin exchange), Visa token clearinghouse 415D, ACH 415E and American Express (AMEX) 415N.

It is to be understood that FIG. 4 illustrates just a few example third party payment services. There may be a very large number of different and/or additional third party payment services 415 that may be supported. The third party payment services 415 may be any type of conventional provider of financial or payment/value card information such as a bank or other financial institution. Furthermore, the third party payment services may include any retail outlet that provides sells physical gift cards or e-gift cards (such as Starbucks, Target, Home Depot, Amazon.com, etc.). Similarly, an e-gift card market or reseller may be a third party payment provider. New crypto-currency providers or exchanges (such as Coinbase or Mt.Gox) may be third party payment providers. Electronic peer-to-peer payment services such as PayPal may operate with the present disclosure. And of course traditional credit card networks (such as Visa, MasterCard, or American Express) may serve as third party payment services. The third party payment services 415 are described in more detail with examples in later sections of this document. It is to be understood that although values associated with the dynamic payment cards 411 can be in the form of “real currency” (e.g., U.S. dollars, Japanese Yen, Euros, etc.) or the values can also be in less traditional currencies such as Bitcoins, e-checks, store credit, video game virtual currencies, airline miles, reward points, loyalty points, etc.

Mobile communication devices 403 and servers 405 can be implemented using computer systems 100 such as the one illustrated in FIG. 1. The mobile communication devices 403 and server 405 are communicatively coupled to the network 407. Mobile communication devices 403 are able to access applications and/or data on network servers (such as server 405) using a web browser or other client software such as the dynamic digital value transfer application 409.

Although FIG. 4 illustrates one server 405, three mobile communication devices 403A through 403N, three dynamic payment cards 411A through 411N, three points of sale 413A through 413N, and six third-party payment systems 415A through 415N as an example, in practice many more (or fewer) of each of these components can be deployed or utilized as needed. In one embodiment, the network 407 is in the form of the internet or a cellular telephone network. Other types of networks 407 or network-based environments can be used in other embodiments.

Multiple Format Programmable Dynamic Credential Card

FIG. 5 illustrates a block diagram of a programmable dynamic credential card 500 that may be used as the dynamic credential cards 411 of FIG. 4. As illustrated in FIG. 5, the programmable dynamic credential card 500 is controlled by on-card microprocessor system 504. The microprocessor system 504 includes a data store 505 for storing software code and information needed for operation. The information needed may include identification information about the user of the programmable dynamic credential card 500, security information, and financial identifier information associated with that user.

The microprocessor system 504 is supported by a number of input and output subsystems. A first output system is the display system 524 that can be used to display alphanumeric text and graphical images to a user. The display system 524 is used in conjunction with a user input system 506 so that a user may interact with the programmable dynamic credential card 500 in order to make selections, enter PIN numbers, and otherwise communicate with the programmable dynamic credential card 500. The user input system may comprise buttons, a keyboard, a touchscreen on top of the display system 524, or any other suitable user input system.

In addition to communicating with a user, the graphical display system 524 may be used to display bar codes, QR codes, and other such coded images in order to transmit information to scanners at Point-Of-Sale (POS) terminals and ticket readers. Thus, the display system 524 can be used to communicate e-gift card identifier information. Similarly, the display system 524 can be used to communicate sports event ticket information, airline ticket information, or concert ticket information.

The programmable dynamic credential card 500 will also generally include a wireless communication module 501 for communicating with other digital computing devices such as personal computer systems or mobile computing devices. In particular, the programmable dynamic credential card 500 will likely often communicated with a mobile computing device 403 such as the user's smartphone. Such wireless communication may occur with Wi-Fi, Bluetooth, Near Field Communication (NFC), Bluetooth LE, or any another suitable wireless communication protocol.

In some embodiments the programmable dynamic credential card 500 may contain a global positioning system (GPS) receiver 503 for tracking the location of the programmable dynamic credential card 500. Location tracking information can be used to have the programmable dynamic credential card 500 make logical inferences as to what information the user may most likely need next and display that information. For example, if the card detects that it is at a particular retailer where the consumer typically uses a particular credit card, the programmable dynamic credential card 500 may prepare itself to act as that credit card. Similarly, if the programmable dynamic credential card 500 detect that it is in close proximity to a particular sporting event arena or concert venue, the programmable dynamic credential card 500 may opt to display the coded information for an appropriate ticket for that sporting event arena or concert venue on this date.

In embodiments without a global positioning system (GPS) receiver 503, the same location-based functionality may be implemented by communicating with the user's smartphone. Specifically, the programmable dynamic credential card 500 may communicate with a user's smartphone 403, obtain location information from that smartphone, and then use that location information to provide the same functionality.

To communicate with Point-Of-Sale (POS) terminals, the programmable dynamic credential card 500 contains one or more subsystems for communicating identification and authentication information to Point-Of-Sale (POS) terminals. Since the current most common type of communication system on financial payment cards is encoded magnetic stripes, a programmable dynamic credential card 500 may have a dynamic magnetic field generation system for emulating a conventional magnetic stripe.

Specifically, the programmable dynamic credential card 500 may include solenoid coil(s) 512 that are driven coil driver circuitry 530 to generate an encoded magnetic field. The coil driver circuitry 530 can be controlled the microprocessor system 504 that provides the identifier information needed to generate the proper magnetic field pattern of the desired convention magnetic stripe card. Details on implementing a dynamic magnetic stripe system can be found in the co-pending U.S. patent application title “Systems And Methods For Creating Dynamic Programmable Magnetic Stripes”, filed on Oct. 26, 2015 and having Ser. No. 14/922,771. If the programmable dynamic credential card 500 determines that it is not secure, the coil driver circuitry 530 will be disabled.

Although the United States currently largely uses magnetic stripe card, there is move underway to use more secure methods of communicating financial identification and authentication information. Furthermore, there are now a wide variety of new types of financial identification systems such as the e-gift cards previously described. Thus, a programmable dynamic credential card 500 may have different or additional subsystems for providing financial identification and authentication information with Point-Of-Sale terminals.

One type of Point-Of-Sale communication system that may be used is the new “Europay, MasterCard, and Visa” (EMV) subsystem 531. As previously described, the EMV system 531 may be a contact or contactless system. In one embodiment, the microprocessor system 504 controls a switch that can deactivate the EMV subsystem 531 such that the EMV subsystem 531 cannot be used if the microprocessor system 504 has determined that proper security requirements have not been met.

Another type of communication system that may be used for communicating with Point-Of-Sale (POS) terminals is the “Near Field Communication” (NFC) subsystem 532. The NFC protocol is a new wireless communication protocol that is being implemented within most smartphones as method of implementing payment systems that only requires the NFC equipped system to be in close proximity to an NFC reader equipped Point-Of-Sale (POS) terminal. The processor 504 may deactivate the NFC subsystem 532 if security precautions have not been satisfied. To reduce costs, the same subsystem may be used to implement both the wireless communication module(s) 501 and the NFC subsystem 532.

Yet another type of Point-Of-Sale communication system that a programmable dynamic credential card 500 may use to communicate with Point-Of-Sale (POS) terminal is a Bluetooth Low Energy (Bluetooth LE) system 533. The Bluetooth LE protocol is designed to minimize energy usage and thus extend battery life for mobile digital devices like the programmable dynamic credential card 500. Again, the same circuitry may be used to implement both the wireless communication module(s) 501 and the Bluetooth LE subsystem 533. Note that the processor 504 may refuse to operate the Bluetooth LE subsystem 533 if security precautions have not been satisfied.

Another type of Point-Of-Sale communication system that the programmable dynamic credential card 500 may use to communicate with Point-Of-Sale (POS) terminal is a Radio Frequency Identification (RFID) system 534. As with the EMV system 531, the RFID system may be deactivated by the microprocessor system 504 if sufficient security requirements have not been fulfilled.

Various different security systems may be used to determine when sufficient security requirements have been met. For example, an associated mobile device may be registered and bonded with the programmable dynamic credential card. Then, if the dynamic programmable credential card can determine that the associated mobile device is present in the immediate vicinity (such as 6 feet) then the security requirement may be deemed fulfilled. This concept of a bonded mobile digital device that is bonded with a specific programmable dynamic credential card will be referred to as an ‘associated mobile device’ in this document. In other embodiment, a Personal Identification Number (PIN) may be entered onto the programmable dynamic credential card to fulfil security requirements.

In some embodiments, a biometric security system 509 may be included in a programmable dynamic credential card 500. The programmable dynamic credential card 500 may require that a user authenticate the user with the biometric security system 509 before the programmable dynamic credential card 500 will operate. The biometric security system 509 may comprise fingerprint reader. Thus, a verified fingerprint on the programmable dynamic credential card 500 or the bonded mobile device may fulfil the security requirements.

In addition to the various subsystems 530 to 534 for communicating with Point-Of-Sale (POS) terminals, a programmable dynamic credential card 500 may also use the display system 524 to communicate with Point-Of-Sale (POS) terminals. For example, a user may receive a gift card that includes a QR code or a bar code that can be presented at a retailer for payment. The microprocessor system 504 can cause the display system 524 to display that QR code or bar code and then the display system 524 may then be presented to the optical scanner of the Point-Of-Sale (POS) terminal for payment. Again, if the programmable dynamic credential card 500 determines that security has been breached, the microprocessor system 504 will not display any QR codes or bar codes on the display system 524.

Note that although the present applications focuses on the application of financial payment cards, the credential abilities and security abilities of the disclosed system may be used in other applications. For example, the teachings of the present disclosure may be for security access cards, medical insurance identification, membership cards, etc.

Programmable Dynamic Digital Value Transfer Functionality Overview

Referring back to FIG. 4, the communication link 450 between the mobile digital device 403 and the programmable dynamic credential card 411 serves as a bridge between the digital world of the dynamic digital value transfer system 401 and the electronic payment systems 415 and the brick & mortar world with its physical Point-Of-Sale terminals 413. Thus, financial transfers in the digital world can be used to conduct business in the brick & mortar physical world. For example, a user may receive an e-gift card from any electronic payment system 415 on their mobile digital device 403, transfer the e-gift card across communication link 450 to the programmable dynamic credential card 411, and then use that received e-gift card in brick & mortar retail stores by using the programmable dynamic credential card 411 at Point-Of-Sale (POS) terminals 413.

Creating New Accounts on Programmable Dynamic Credential Cards

As set forth with reference to FIG. 5, the programmable dynamic credential card 500 of the present disclosure is capable of concurrently supporting many different financial payment accounts with many different Point-Of-Sale (POS) communication technologies. In order to support a particular financial payment account, the identification information and associated authentication information from that financial payment account must first be entered into the programmable dynamic credential card 500. Different financial payment accounts will require different information and different methods of entering the information into the programmable dynamic credential card 500.

Two of the Point-Of-Sale (POS) communication technologies that the programmable dynamic credential card 500 supports require specific individualized hardware in order to operate. Specifically, the EMV system 531 requires a unique security integrated circuit on the card and the RFID system 534 requires a unique Radio Frequency Identifier circuit. To support such systems, an issuer of an EMV or RFID based financial payment card would need to put such circuits into a programmable dynamic credential card 500 before sending the programmable dynamic credential card 500 to their customer.

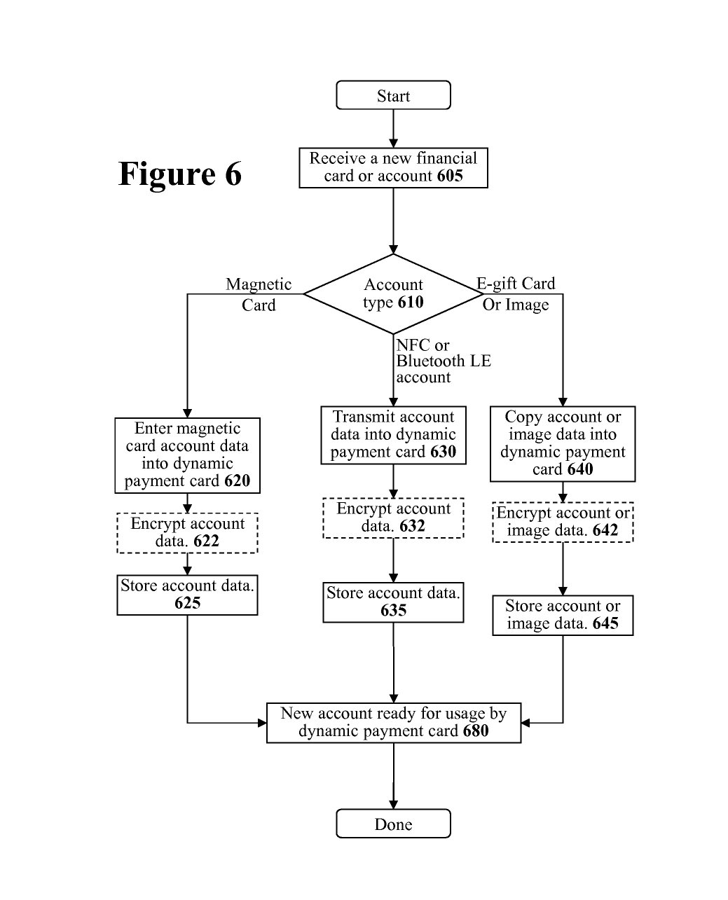

The other types of financial payment accounts and cards may be added to a programmable dynamic credential card 500 at any time. FIG. 6 illustrates how other types of financial payment accounts and financial payment cards may be added to a programmable dynamic credential card 500.

Referring to the top of FIG. 6, the user of a programmable dynamic credential card 500 receives a new financial payment card, e-gift card, financial payment account, or other such account at stage 605. The steps that will be followed to add the new financial payment account or financial payment card to the programmable dynamic credential card 500 will depend on what type account is to be added. Thus, at stage 610, the process follows a different path depending on the type of account. Note that although this application focuses upon financial payment accounts, other types of accounts such as membership accounts, security identifier accounts, or other such accounts may be added to the programmable dynamic credential card 500.

If a conventional magnetic financial payment card is received then one proceeds to stage 620 where the account data from the magnetic card account may be entered into the programmable dynamic credential card 500. The account information includes the name of the account, the account number, the expiration date, and the Card Verification Value (CVV) number. This can be accomplished in many different ways. A user may directly enter the information into the programmable dynamic credential card 500 using the user input system 506. Referring to FIG. 4, a user may enter the information into the dynamic digital value transfer application 409 on the user's mobile digital device 403 and that dynamic digital value transfer application 409 will then transmit that information to the associated programmable dynamic credential card 411. Similarly, a user may enter the information into a personal computer (not shown) and that personal computer may transmit the information to the user's programmable dynamic credential card 500 using the wireless communication module 501 on the card. In other embodiments, the issuer of a magnetic stripe credit card may electronically transmit the account information to the user's mobile digital device 403 and the mobile digital device 403 then transmits it to the user's programmable dynamic credential card 500.

After entering the account information into the user's programmable dynamic credential card 500, the programmable dynamic credential card 500 may then encrypt the account data on the programmable dynamic credential card 500 during an optional encryption stage 622 to keep the information secure. The information is then stored on the programmable dynamic credential card 500 in a non-volatile manner. At this point the new account creation is complete and the new account is ready for use at stage 680.

Referring back to stage 610, if the new account uses Near Field Communication (NFC), Bluetooth LE, or other type of standardized wireless communication then the information associated with such accounts must be entered into the programmable dynamic credential card 500. Specifically, at stage 630 the account information is transmitted to the programmable dynamic credential card 500. NFC and Bluetooth payment systems are typically accounts that are created within mobile digital devices like smartphones. Thus, a user can have their mobile digital device 403 transmit the required information to the user's programmable dynamic credential card 411. The user could also manually enter the needed information into the programmable dynamic credential card 411 using the user input system 506.

After transmitting the NFC or Bluetooth LE account information into the user's programmable dynamic credential card 500, the programmable dynamic credential card 500 may then encrypt the account data on the programmable dynamic credential card 500 during an optional encryption stage 632 to keep the information secure. Finally, the programmable dynamic credential card 500 stores the NFC or Bluetooth LE account information into a non-volatile memory on the programmable dynamic credential card 500 at stage 635. At this point the new NFC or Bluetooth LE account is ready for use at stage 680.

Referring back to stage 610, if the new account E-gift card, a stored value card, or some other type of account that uses an image or an identifier code then that image or an identifier code must be copied into the programmable dynamic credential card 500. Thus, at stage 640 the image or an identifier code associated with the new e-Gift account is copied into the programmable dynamic credential card 500. In one embodiment, a plug-in application in an email client may identify images or an identifier codes associated with a payment account and automatically transmit that information to the programmable dynamic credential card 500. A user may also manually enter an account identifier from an email message into the programmable dynamic credential card 411 using the user input system 506. In some embodiments, a user may be able to directly send an e-gift card directly to the dynamic digital value transfer application 409 on the user's mobile digital device 403 such that the dynamic digital value transfer application 409 can then transmit the image or account to the associated programmable dynamic credential card 411.

In one embodiment, a user may take a picture of the encoded image with the user's mobile digital device 403. The dynamic digital value transfer application 409 may then analyze that encoded image and pass the needed information to the user's programmable dynamic credential card 500.

After transmitting the appropriate image or identifier code information to the user's programmable dynamic credential card 500, the programmable dynamic credential card 500 may then encrypt the account data on the programmable dynamic credential card 500 during an optional encryption stage 642 to keep the information secure. Finally, at stage 645, the programmable dynamic credential card 500 stores the image or identifier code information into a non-volatile memory on the programmable dynamic credential card 500. At this point the new E-gift card, a stored value card, or some other type of account that uses an image or an identifier code is ready for use at stage 680.

Note that this ability to easily create new accounts at any time enables the ability to easily send e-gift cards to people with a programmable dynamic credential card 411 in real time. For example, a person may suddenly remember that it is a friend's birthday that day. That person can then send an e-gift card to their friend either by email or directly to the dynamic digital value transfer application 409 on their friend's smartphone. The dynamic digital value transfer application 409 may automatically create the e-gift card account in the programmable dynamic credential card 411 so the friend can immediately make a purchase. When the friend receives the e-gift card, the dynamic digital value transfer application 409 may alert the friend that a gift has been received and give the friend an option of sending a “Thank You” note. After the friend makes a purchase with the gift card, the programmable dynamic credential card 411 may inform the dynamic digital value transfer application 409 such that the dynamic digital value transfer application 409 may suggest the friend send a picture of the item purchased with the e-gift card to the person that sent the e-gift card.

Adding Value to Accounts Associated with a Dynamic Credential Card

As set forth earlier in this document, pretty much all credit cards, debit cards, e-gift cards, stored value cards, and other payment services operate by storing the actual financial value associated with an account on a back-end server system at a financial service. The user is merely given account identification (and sometimes authentication) information in the form of a financial payment card, account code, image, or other suitable account identification information. The user provides that account identification information to a Point-Of-Sale terminal when conducting a transaction and then the Point-Of-Sale terminal communicates with the back-end server system at a financial service. Thus, if a person wishes to add value to a particular account on a programmable dynamic credential card 500, the person can contact the third party payment service 415 that operates the associated account payment directly. For example, a user may use a personal computer system to directly contact PayPal 415B to add value to their associated PayPal account.

A user may also use their mobile digital device 403 to contact their third party payment service provider 415. The user can use the dynamic digital value transfer application 409 on their mobile digital device 403 to execute value transfers. The dynamic digital value transfer application 409 may then communicate with the server-based dynamic digital value transfer system 401 that can execute transactions between the various third party payment service providers 415.

Using a Programmable Dynamic Credential Card

Once a programmable dynamic credential card 500 has been set up with at least one payment account, the user can use the programmable dynamic credential card 500 as a payment card in brick & mortar retail stores. Better yet, when multiple different payment accounts have been set up on a programmable dynamic credential card 500 the user only has to carry that single programmable dynamic credential card 500 to perform financial transaction with any of those multiple different payment accounts. As noted earlier, the single programmable dynamic credential card 500 can handle multiple different financial payment accounts that use multiple different communication systems with Point-Of-Sale (POS) terminals including magnetic stripe card interfaces, contact EMV interfaces, contactless EMV interfaces, NFC interfaces, Bluetooth LE interfaces, barcode interfaces, QR code interfaces, and RFID interfaces. Additional Point-Of-Sale (POS) terminal interfaces can be added to new programmable dynamic credential cards as needed.

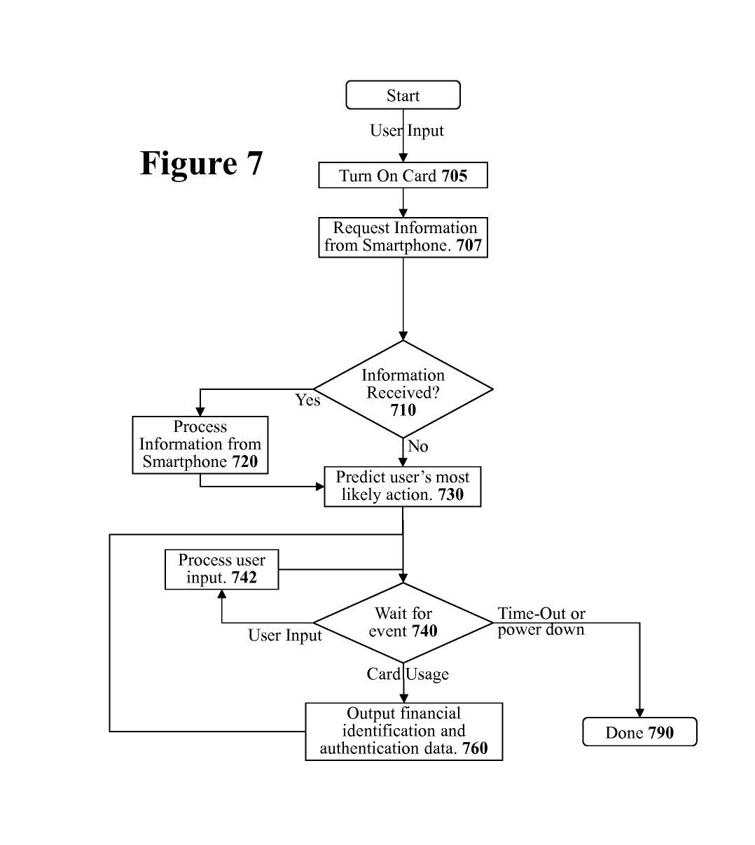

FIG. 7 illustrates a flow diagram that discloses one embodiment of how the programmable dynamic credential card 411 of the present disclosure may be used during conventional brick & mortar store retail purchases. When the user wishes to use the card, the user turns on the programmable dynamic credential card 411 at stage 705. The programmable dynamic credential card 411 quickly activates itself and begins to prepare for usage.

One of the first things the programmable dynamic credential card 411 does is to request information from an associated mobile digital device 403. If the programmable dynamic credential card 411 receives a response from the associated mobile digital device 403 at stage 710, the programmable dynamic credential card 411 will then process the information received from the associated mobile digital device 403 at stage 720. The programmable dynamic credential card 411 will use the information from the associated mobile digital device 403 to predict how the user most likely wants to use the programmable dynamic credential card 411. For example, the programmable dynamic credential card 411 may receive location information that helps suggest the most likely payment system that the user wishes to use. The programmable dynamic credential card 411 may receive a direct suggestion from the dynamic digital value transfer application 409 on the associated mobile digital device 403 as to which payment account to use. If no information is received from an associated mobile digital device 403 then the programmable dynamic credential card 411 will have to make its own determination as to which payment account the user most likely wants to use. This may simply be the last payment account that was used.

In some embodiments, the user's associated mobile digital device 403 or the programmable dynamic credential card 411 may monitor for local signals that help pick which payment account to use. For example, the retailer may emit a Bluetooth beacon that helps the card select a particular payment account. Or the Point-Of-Sale terminal may send a signal that helps the card select a particular account. The information used may include very specific location information such as which shop in a mall that a user is in or even which particular aisle within the shop the customer is located. Furthermore, the retailer may send a message informing the user that a discount coupon that will be triggered only when a specific payment card such as the store card is selected.

The programmable dynamic credential card 411 then proceeds to stage 740 where it waits for an event. Various different events may occur and the programmable dynamic credential card 411 will respond as appropriate.

If the programmable dynamic credential card 411 receives user input at stage 740 then the programmable dynamic credential card 411 proceeds to stage 742 to process the user input and respond appropriately. For example, the user may scroll through a list of different payment accounts to select a different payment account to use. The user may perform some other maintenance activity. For example, the user may add a new payment account or remove an existing payment account.

If no event occurs within a defined time-out period then the programmable dynamic credential card 411 proceeds to a power down stage 790. Similarly, if the user indicates that the programmable dynamic credential card 411 should power down then the programmable dynamic credential card 411 proceeds to a power down stage 790.

Referring back to stage 740, if the user proceeds to use the programmable dynamic credential card 411, then the programmable dynamic credential card 411 response appropriately at stage 760 depending on the type of Point-Of-Sale (POS) terminal communication system. For example, if the programmable dynamic credential card 411 detects the start of a swipe through a magnetic card reader then the programmable dynamic credential card 411 will output the appropriate magnetic field reversals to act as a conventional magnetic stripe card. If the programmable dynamic credential card 411 is dipped into a contact EMV card reader, the programmable dynamic credential card 411 will output the EMV account identification information if appropriate. If the programmable dynamic credential card 411 detects that it is placed in front of a bar code scanner, the programmable dynamic credential card 411 may display an appropriate bar code on the display system of the programmable dynamic credential card 411. The programmable dynamic credential card 411 may detect a nearby scanner system using a light detector that is sensitive to the particular wavelengths of light used by lasers in optical scanning systems. If the programmable dynamic credential card 411 is placed in close proximity to an NFC reader or a Bluetooth LE reader, the programmable dynamic credential card 411 may transmit the appropriate account information to the NFC reader or a Bluetooth LE reader.

After responding to a card usage attempt at stage 760 the programmable dynamic credential card 411 returns back to stage 740 to wait for another event. Since sometimes card usage attempts do not succeed on the first attempt, the user may attempt to use the card again such that the programmable dynamic credential card 411 will repeat stage 760. The user may decide to select a different payment account such that the programmable dynamic credential card 411 will process the user's input appropriately at stage 742. If the user is done using the card, the user may power down the card or the card may time-out itself and proceed to the powered down stage 790.

Enhanced Security Transactions with Dynamic Credential Cards

The programmable dynamic credential card 411 of the present disclosure is capable of provide much better security features than is provided by conventional financial payment card systems such as magnetic stripe cards or even the newer more secure EMV types of financial payment cards. Specifically, the programmable dynamic credential card 411 can implement a two token security system that greatly enhances financial transaction security.

Referring back to the architecture diagram of FIG. 4, it can be seen that each programmable dynamic credential card 411 will generally have an associated mobile digital device 403 such as a smartphone. As previously set forth, this allows the user to perform operations with the better user interface features provided by the mobile digital device 403. Most people now carry a mobile digital device 403 such as a smart phone all the time now. However, the smartphones are often carried in different manner than a financial payment card. For example a smartphone may be in a front pocket and a financial payment card (such as the programmable dynamic credential card 411) may be carried in a back-pocket wallet. Or a programmable dynamic credential card 411 may be in purse while a smartphone is in a belt-clip or holster. This allows for two different digital security tokens to be carried separately thereby greatly improving security.

In the two token security system, a first security token (such as account information) is in the programmable dynamic credential card 411 and a second digital security token (such as a digital key) is in the associated mobile digital device 403. In this manner, if a thief manages to steal a programmable dynamic credential card 411 but not the associated mobile digital device 403, the programmable dynamic credential card 411 can render itself inoperable. The associated mobile digital device may be a smartphone, a smart watch, a physical activity tracker, a tablet computer system, or any other type of digital device with the needed communication systems.

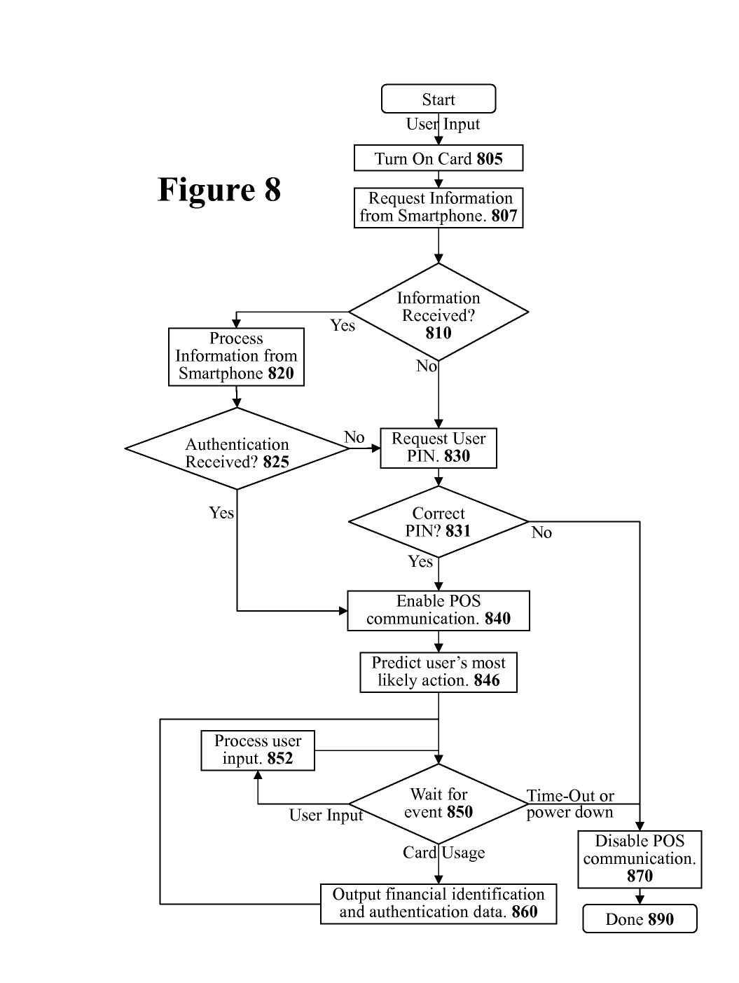

FIG. 8 illustrates a flow diagram describing how the two security token system may operate. The flow diagram of FIG. 8 will be described with reference back to the architectural elements of FIG. 4. Referring to the top of FIG. 8, the user first activates the programmable dynamic credential card 411 at stage 805. The programmable dynamic credential card 411 then requests information from the associated mobile digital device 403 at stage 807. This request includes a request for the security token stored in the associated mobile digital device 403.

If no response is received from the associated mobile digital device 403, then the programmable dynamic credential card 411 then the programmable dynamic credential card 411 assumes that it may have been stolen. It thus proceeds to stage 830 where it requests a PIN number from the user. If the user enter cannot enter the correct PIN number at stage 831 then the programmable dynamic credential card 411 proceeds to stage 870 where it turns off all Point-Of-Sale (POS) communication systems (if they were on) and then turns itself off at stage 890.

If a response is received from the associated mobile digital device 403 then the programmable dynamic credential card 411 processes the information received at stage 820. Next, at stage 825, the programmable dynamic credential card 411 uses appropriate security means to authenticate the security token received from the from the associated mobile digital device 403. If it cannot properly authenticate the security token received from the associated mobile digital device 403 then the programmable dynamic credential card 411 proceeds to stage 830 where it requests a PIN number from the user in order to continue operating as described in the previous paragraph.

If the programmable dynamic credential card 411 receives the appropriate security token and authenticates it at stage 825, or the user enters the proper PIN number at stage 831 then the programmable dynamic credential card 411 proceeds to stage 840 where it then enables the various communication systems that can be used with Point-Of-Sale (POS) terminals. The system them proceeds in the same manner as described in FIG. 7.

The dual token security system of disclosed in FIG. 8 greatly increases the security of the programmable dynamic credential card 411 without burdening the user of the programmable dynamic credential card 411. In most cases, the user will simply use the programmable dynamic credential card 411 just like a conventional magnetic stripe payment card. However, without the user's knowledge, the programmable dynamic credential card 411 will be performing a second security check by ensuring that the user with the associated mobile digital device 403 is using the programmable dynamic credential card 411.

If the user has had both their programmable dynamic credential card 411 and their associated mobile digital device 403 stolen then the user can send a message to the dynamic digital value transfer application 409 on the associated mobile digital device 403 to destroy the security token. Alternatively, the dynamic digital value transfer application 409 on the associated mobile digital device 403 may periodically communicate with the dynamic digital value transfer system 401 to ensure that this associated mobile digital device 403 and/or programmable dynamic credential card 411 have not been reported stolen. If a theft is reported or the associated mobile digital device 403 is unable to communicate with the dynamic digital value transfer system 401 then the dynamic digital value transfer system 401 and the programmable dynamic credential card 411 will render themselves inoperable. This will then cause the programmable dynamic credential card 411 to require a PIN code to operate that the thief will not know. Thus, the thief will be unable to use the programmable dynamic credential card 411.

One-Time Usage Accounts

Consumers sometimes need one-time usage account numbers. For example, if a consumer is not certain that his account number will be protected by a potentially unscrupulous vendor or if a user feels that the communication line maybe compromised. Furthermore, a consumer may want to give a one-time usage account number to another person as a gift. These one-time usage financial account numbers may or may not have a credit or debit limit. The system of the present disclosure provides users with a method of securely obtaining one-time usage account numbers in real-time.

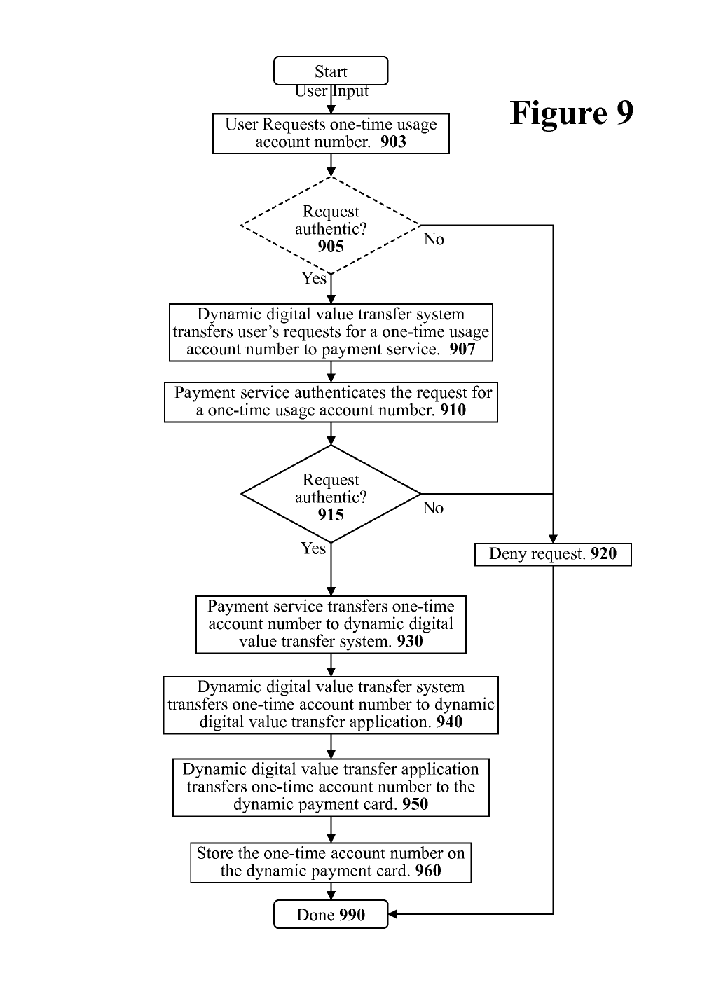

FIG. 9 illustrates a flow diagram describing how the system of the present disclosure can be used to quickly obtain one-time usage financial account numbers. The flow diagram of FIG. 9 will be described with reference to the network architecture diagram of FIG. 4.

Referring to the top of FIG. 9, a user requests a one-time usage account number at stage 903. This request for a one-time usage account number may be done in many different ways. For example, the user may make the request for the one-time usage financial account number on the dynamic digital value transfer application 409 on their mobile digital device 403. The dynamic digital value transfer application 409 passes the request to the dynamic digital value transfer system 401 on server 405. The dynamic digital value transfer system 401 authenticates the request and discards the request if it is not authentic at stage 920. Assuming an authentic request at stage 905, the dynamic digital value transfer system 401 then passes along the request for a one-time usage account number to the appropriate third party payment service 415 at stage 907.

Referring back to stage 903, it was mentioned at the request may be made in many different ways. For example, the user may make the request for a one-time account number directly on the user's programmable dynamic credential card 411A for a specific credit/debit card provider. The programmable dynamic credential card 411A will then pass the request to the dynamic digital value transfer application 409. Then dynamic digital value transfer application 409 then passes the request for a one-time use number to the dynamic digital value transfer system 401 on server 405. And the system proceeds starting at stage 905 as described in the previous paragraph. Users can also make requests for one-time account numbers using any computer system that can access the dynamic digital value transfer system 401 on server 405. For example, a user running a web browser on a personal computer system may contact a web interface on the dynamic digital value transfer system 401 on server 405. The user may then make a request for a one-time usage account number. After receiving the request for the one-time usage account number, the system can then proceed starting at stage 905 as described in the previous paragraph.

Referring back to stage 910, regardless of how the request for a one-time usage account number is made, the third party payment service makes its own determination as to whether the request for a one-time account number is authentic. Note that two different authentications are performed in this embodiment thus improving security. If the third party payment service determines that the request is not authentic at stage 915 then the request is denied at stage 920. When a request is determined to be authentic at stage 915, then the third party payment service responds to the request with a one-time usage number to the dynamic digital value transfer system 401 on server 405 at stage 930.

The dynamic digital value transfer system 401 then passes the one-time usage number to the dynamic digital value transfer application 409 on their mobile digital device 403 at stage 940. In some embodiments, the dynamic digital value transfer application 409 stores a copy of the one-time usage number such that the user can make purchases using the one-time usage number with the dynamic digital value transfer application 409 using NFC or another payment communication system supported by the mobile digital device 403.

But to provide much greater flexibility, the system of the present disclosure then passes the one-time usage number from the dynamic digital value transfer application 409 to the user's programmable dynamic credential card 411A at stage 950. Finally, at stage 960, the programmable dynamic credential card 411A then stores the one-time usage number (in encrypted form) locally in the data store 505 of FIG. 5.

With one-time usage number stored in the data store 505 of the programmable dynamic credential card 500, the programmable dynamic credential card 500 can use that one-time usage number with any of the Point-of-Sale (POS) communication systems available on the card that is supported by that one-time usage number. Thus, the one-time usage number may be communicated with the EMV system 531. The one-time usage number may be transmitted with the wireless NFC system 532 or the wireless Bluetooth LE system 533. The one-time usage number may be communicated with the RFID system 534.

The one-time usage number may even be transmitted to a POS terminal with a magnetic card reader using the solenoid coils 512 and the associated coil driver circuitry 530. Thus, a one-time usage account number can be used with a format that could only previously be used with static identifiers encoded on simple magnetized stripes. To obtain even greater security, the one-time usage account number may be digitally signed with some identification information from the user such that payment systems knows that it is actually their customer using the one-time usage number instead of someone that might have somehow stolen the one-time usage number.

As set forth with reference to FIG. 9 the system of the present disclosure provides means of obtaining one-time usage account numbers in real-time. The one-time usage account numbers can then be stored on the programmable dynamic financial credential card. The one-time usage account numbers may be used with any of the multiple different types of Point-of-Sale (POS) terminal communication systems.

Using the Programmable Dynamic Credential Card for Online Payments

As set forth with reference to FIG. 9 the system of the present disclosure provides means of obtaining one-time usage account numbers. The same techniques disclosed in FIG. 9 can also be used to distribute time-limited (or one-time usage) Card Verification Value (“CVV”) numbers that are used for online transactions. Time-limited (or one-time usage) CVV numbers for use with an associated credit card number can significantly improve security for internet based credit card purchases. For one-time usage CVV numbers, the system described in FIG. 9 may be used to obtain one-time usage CVV numbers.

Instead of one-time CVV numbers, time-limited CVV numbers may be used. For example, a programmable dynamic credential card may request a new CVV number everyday such that CVV number is changed on a daily basis. The programmable dynamic credential card and the associated dynamic digital value transfer application may request new CVV numbers on a daily basis on their own.

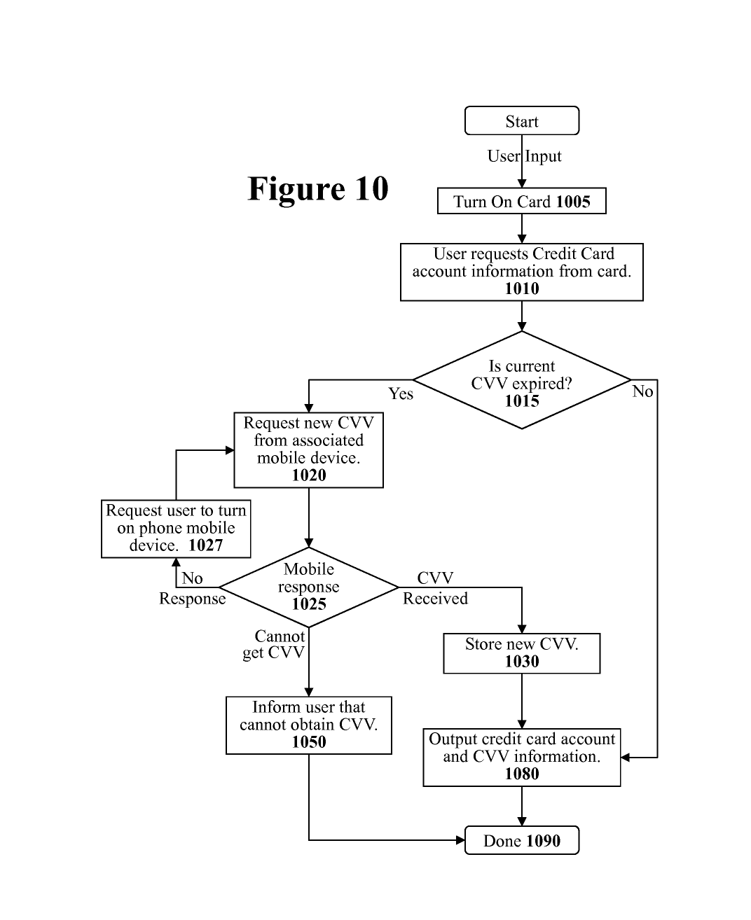

FIG. 10 illustrates a flow diagram describing how the programmable dynamic credential card of FIG. 5 may be used to provide dynamic CVV numbers to improve security for internet based purchases. Referring to stage 1005, a user turns on their programmable dynamic credential card 500. Next, at stage 1010, the user navigates the user interface to request credit card information in order to complete a purchase from an internet-based retailer.

Upon receiving a request, the programmable dynamic credential card first tests if the current CVV number is expired at stage 1015. If the CVV number is not expired, the programmable dynamic credential card can proceed immediately to stage 1080 where it displays the credit card account information and the CVV number to the user so the user may complete their internet-based retail transaction.

Referring back to stage 1015, if the current CVV number is expired, the system proceeds to stage 1020 where the programmable dynamic credential card requests a new CVV number from the dynamic digital value transfer application on the associated mobile device. The dynamic digital value transfer application will forward the request for a new CVV up the communication channel as set forth in FIG. 9. The programmable dynamic credential card will wait for a response from the dynamic digital value transfer application on the associated mobile device.

Stage 1025 illustrates how the programmable dynamic credential card responds to the response (or non-response) from the dynamic digital value transfer application. If no response is received within a predetermined time, then the programmable dynamic credential card may request the user to turn on their mobile device and ensure that the dynamic digital value transfer application at stage 1027 before making another request to the dynamic digital value transfer application for a new CVV number.

If the dynamic digital value transfer application returns a new CVV number then the programmable dynamic credential card proceeds to stage 1030 where it stores the new CVV value. The CVV number may be stored in encrypted form for security. Next, the programmable dynamic credential card outputs the credit card information and the new CVV number at stage 1080 so the user can complete their transaction with an internet-based retailer.

Referring back to stage 1025, if the dynamic digital value transfer application informs that it cannot obtain a new CVV number or if no response is received after several attempts, the programmable dynamic credential card may proceed to stage 1050 where it informs the user that it cannot obtain a new CVV number.

Using the Dynamic Credential Card for App Authentication

Users often store very confidential information on their smartphones. However, smartphones are frequently hacked to obtain the confidential information within those smartphones. Furthermore, a user's smartphone may be stolen or otherwise accessed by an unauthorized user. Therefore, it would be desirable to improve the security of smartphones (and other similar mobile digital devices).

To accomplish this goal, the system of the present disclosure allows a user's programmable dynamic credential card 411A to be used as an authentication system for accessing information on the user's smartphone. Specifically, the programmable dynamic credential card 411A has been designed with strong security in mind since it is used for storing multiple different payment service accounts. Thus, it is designed to limit unauthorized access and the data on it is generally encrypted. This programmable dynamic credential card 411A functionality can be used to provide greater security to applications on the user's associated mobile digital device 403 (such a smartphone). As mentioned earlier, people often carry their smartphones and their financial payment cards in different pockets thus making the chance of losing both together relatively low.

To describe how a programmable dynamic credential card 411A can be used to provide greater security to applications on the user's associated mobile digital device 403, a password storage vault application is used as an example. A password storage vault application is used to store multiple different passwords that a user must use but has difficulty remembering all of the different passwords. However, this is just an example application and any application that could benefit from greater security could use the teachings of the present application.

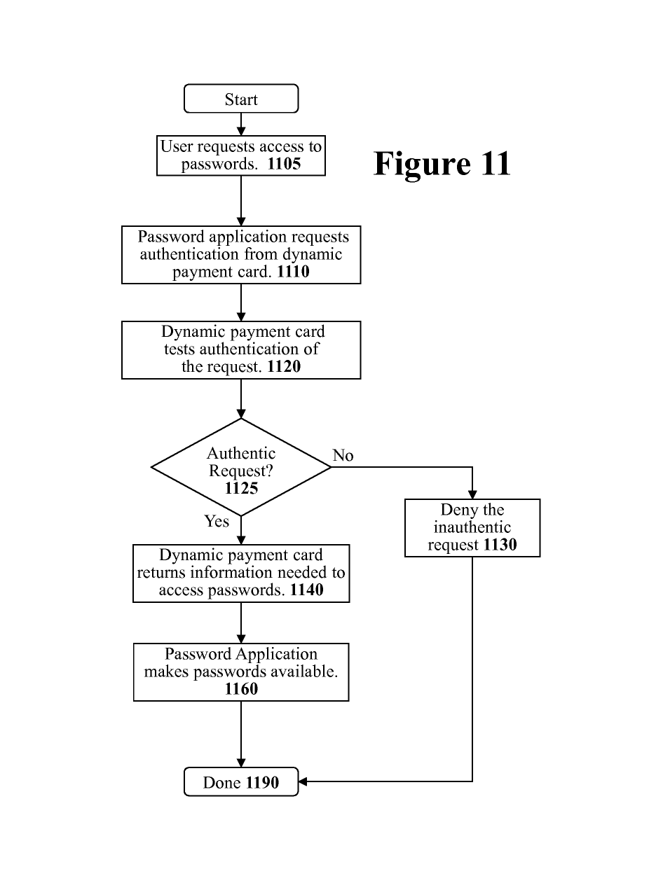

FIG. 11 illustrates a flow diagram describing a first implementation of how a card-assisted security system may operate. Initially, at stage 1105, the user requests access to passwords in the password vault application. The request to access the password vault generally requires the user to enter a master password. Next, the password vault application then requests authentication from the user's programmable dynamic credential card 411A at stage 1110. This communication uses the wireless communication module 501 on the programmable dynamic credential card 500 of FIG. 5.

Referring back to FIG. 11, the programmable dynamic credential card tests the authentication of the request at stage 1120. This test may use information from the password entered by the user. If at stage 1125, the request is determined not to be authentic then the user's programmable dynamic credential card 411A may deny access to the password vault at stage 1130. Thus, if the user of the application does not have the programmable dynamic credential card 411A or enters the wrong password then that user will not be able to access the password vault.

Referring back to stage 1125, if the request is authenticated then the programmable dynamic credential card 411A decrypts needed information to access the password vault and returns that information back to application on the user's smartphone at stage 1140. Finally, at stage 1160, the password vault application uses the returned information (that can only be obtained from the secure programmable dynamic credential card 411A) to make the passwords available to the user.

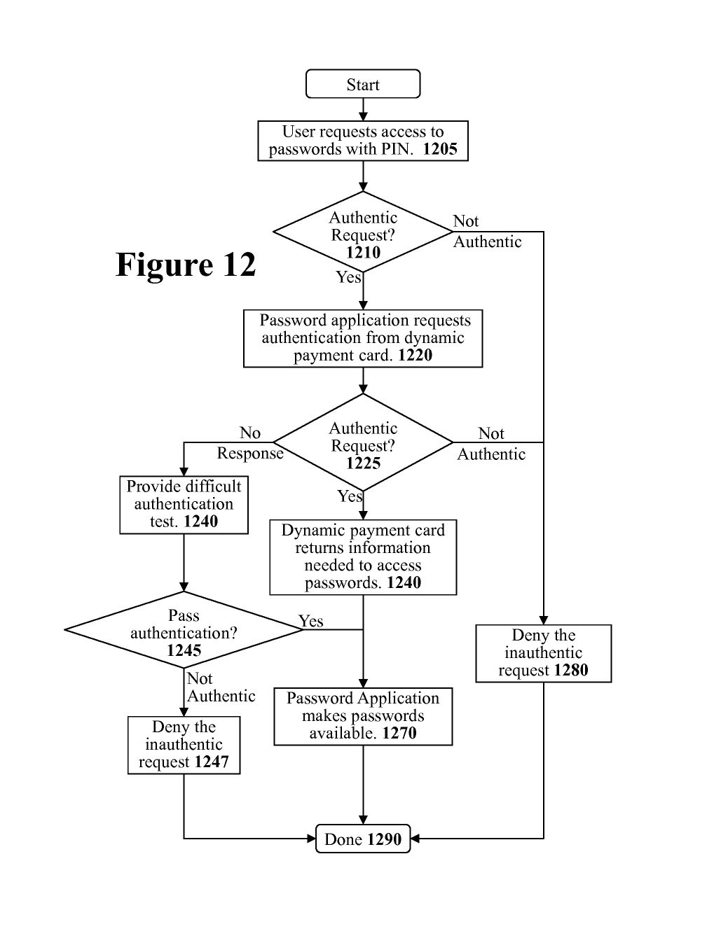

FIG. 12 illustrates an alternative embodiment of a system that uses the security functionality of a programmable dynamic credential card 411A to provide greater security to an application running on a user's associated mobile digital device 403 (such a smartphone). The embodiment of FIG. 12 provides two different ways of opening the password vault (or other application that uses these security features).

Referring to the top of the flow diagram of FIG. 12, a user may request access to the password vault using a simple personal identification number (PIN) or other simple security system 1205. If the PIN is not authentic then the request is denied at stage 1280. If the PIN is authentic, the password application requests authentication from the user's programmable dynamic credential card 411A at stage 1220 and waits for a response.

At stage 1225, the programmable dynamic credential card 411A tests if the request is authentic. If the request is not authentic then the request is denied at stage 1280. If the request is authentic then the programmable dynamic credential card 411A decrypts and returns information that will allow the password vault to be accessed at stage 1230. The password vault application can then use the returned information to make the passwords available at stage 1270.

Referring back to stage 1225, if no response is received from the programmable dynamic credential card 411A, then the password vault application proceeds to stage 1240 where the password application provides a much more difficult authentication test. This may require a long complex password, a fingerprint, or some other strict authentication test to be passed to allow the user to access the password vault without having the programmable dynamic credential card 411A. If the user cannot pass the difficult authentication test at stage 1245 then the request is denied at stage 1247.

Referring back to stage 1245, if the user passes the difficult authentication test then the password vault application makes the passwords available at stage 1270. Note that the in one embodiment, the information needed to access password vault returned at stage 1230 may be the same as the password that is required at stage 1240. Thus, in the embodiment of FIG. 12, the user can either just enter a simple PIN at stage 1205 and have their programmable dynamic credential card 411A with them, or the user can pass a difficult authentication test at stage 1240 in order to access their password vault.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A dynamic credential card system for interoperating with multiple different point-of-sale systems, said dynamic credential card system comprising the elements of:
a dynamic digital value transfer system executing on a networked server system, said dynamic digital value transfer system able to communicate with a plurality of third party financial payment services;
a dynamic digital value transfer application, said dynamic digital value transfer application executing on a mobile digital device with a first wireless communication system, said dynamic digital value transfer application able to communicate with said dynamic digital value transfer system using said first wireless communication system; and
a dynamic credential card, said dynamic credential card comprising
a microprocessor system,
a second wireless communication system, said dynamic credential card able to communicate with said dynamic digital value transfer application on said mobile digital device using said second wireless communication system, and
at least one dynamic point-of-sale communication system for communicating with said multiple different point-of-sale systems, said at least one dynamic point-of-sale communication system under control of said microprocessor system.

2. The dynamic credential card system for interoperating with multiple different point-of-sale systems as set forth in claim 1 wherein said at least one dynamic point-of-sale communication system comprises a dynamic magnetic stripe system.

3. The dynamic credential card system for interoperating with multiple different point-of-sale systems as set forth in claim 1 wherein said at least one dynamic point-of-sale communication system comprises an EMV chip system controlled by said processor system.

4. The dynamic credential card system for interoperating with multiple different point-of-sale systems as set forth in claim 1 wherein said at least one dynamic point-of-sale communication system comprises a Near Field Communication (NFC) system controlled by said processor system.

5. The dynamic credential card system for interoperating with multiple different point-of-sale systems as set forth in claim 1 wherein said at least one dynamic point-of-sale communication system comprises a Bluetooth communication system controlled by said processor system.

6. The dynamic credential card system for interoperating with multiple different point-of-sale systems as set forth in claim 1 wherein said at least one dynamic point-of-sale communication system comprises a Radio Frequency Identifier (RFID) communication system controlled by said processor system.

7. The dynamic credential card system for interoperating with multiple different point-of-sale systems as set forth in claim 1 wherein said at least one dynamic point-of-sale communication system comprises display system controlled by said processor system, said display system capable of displaying QR codes and barcodes.

8. The dynamic credential card system for interoperating with multiple different point-of-sale systems as set forth in claim 1 wherein said dynamic digital value transfer system obtains financial account information from one of said plurality of third party financial payment services and transfers said financial account information to said dynamic digital value transfer application with said first wireless communication system, and said dynamic digital value transfer application transfers said financial account information to said dynamic credential card with said second wireless communication system.

9. The dynamic credential card system for interoperating with multiple different point-of-sale systems as set forth in claim 1 wherein said mobile digital device comprises a smartphone or smartwatch.

10. The dynamic credential card system for interoperating with multiple different point-of-sale systems as set forth in claim 8 wherein said financial account information from one of said plurality of third party financial payment services comprises a one-time-usage credential token.

11. The dynamic credential card system for interoperating with multiple different point-of-sale systems as set forth in claim 1 wherein one of said plurality of third party financial payment services comprises Automated Clearing House (ACH) for e-checks.

12. The dynamic credential card system for interoperating with multiple different point-of-sale systems as set forth in claim 1 wherein one of said plurality of third party financial payment services comprises Paypal.

13. The dynamic credential card system for interoperating with multiple different point-of-sale systems as set forth in claim 1 wherein one of said plurality of third party financial payment services comprises a Bitcoin exchange.

14. The dynamic credential card system for interoperating with multiple different point-of-sale systems as set forth in claim 1 wherein one of said plurality of third party financial payment services comprises a gift-card service.

15. A method for implementing a dynamic credential card system for interoperating with multiple different point-of-sale systems, said method comprising:
executing a dynamic digital value transfer system on a networked server system, said dynamic digital value transfer system able requesting an payment account number from a third party financial payment service;
executing a dynamic digital value transfer application on a mobile digital device, said dynamic digital value transfer application receiving said payment account number from dynamic digital value transfer system over a first wireless communication system;
receiving said payment account number into a processor system controlled dynamic credential card over a second wireless communication system; and
communicating said payment account number from said processor system controlled dynamic credential card to a point-of-sale terminal using at least one dynamic point-of-sale communication system.

16. The method for implementing a dynamic credential card system as set forth in claim 15 wherein said at least one dynamic point-of-sale communication system comprises a dynamic magnetic stripe system.

17. The method for implementing a dynamic credential card system as set forth in claim 15 wherein said at least one dynamic point-of-sale communication system comprises an EMV chip system controlled by said processor system.

18. The method for implementing a dynamic credential card system as set forth in claim 15 wherein said at least one dynamic point-of-sale communication system comprises a Near Field Communication (NFC) system controlled by said processor system.

19. The method for implementing a dynamic credential card system as set forth in claim 15 wherein said at least one dynamic point-of-sale communication system comprises a Bluetooth communication system controlled by said processor system.

20. The method for implementing a dynamic credential card system as set forth in claim 15 wherein said at least one dynamic point-of-sale communication system comprises a Radio Frequency Identifier (RFID) communication system controlled by said processor system.

21. The method for implementing a dynamic credential card system as set forth in claim 15 wherein said at least one dynamic point-of-sale communication system comprises display system controlled by said processor system, said display system capable of displaying QR codes and barcodes.

22. The method for implementing a dynamic credential card system as set forth in claim 15, said method further comprising:
requesting a one-time-usage credential token from said third party financial payment service;
transmitting said one-time-usage credential token to said dynamic digital value transfer application on said mobile digital device;
transmitting said one-time-usage credential token from said dynamic digital value transfer application to said processor system controlled dynamic credential card; and
communicating said one-time-usage credential token from said processor system controlled dynamic credential card to a point-of-sale terminal using at least one dynamic point-of-sale communication system.

23. The method for implementing a dynamic credential card system as set forth in claim 15 wherein said mobile digital device comprises a smartphone or smartwatch.

24. The method for implementing a dynamic credential card system as set forth in claim 15 wherein said dynamic credential card further comprises a GPS receiver system.

25. The method for implementing a dynamic credential card system as set forth in claim 15 wherein said third party financial payment service comprises Automated Clearing House (ACH) for e-checks.

26. The method for implementing a dynamic credential card system as set forth in claim 15 wherein said third party financial payment service comprises Paypal.

27. The method for implementing a dynamic credential card system as set forth in claim 15 wherein said third party financial payment service comprises a Bitcoin exchange.

28. The method for implementing a dynamic credential card system as set forth in claim 15 wherein said third party financial payment service comprises a gift-card service.
